(19) United States
(12) Patent Application Publication
(10) Pub. No.: US 2008/0104101 A1
(43) Pub. Date: May 1, 2008

(54) Producing a feature in response to a received expression

(76) Inventors: Evan R. Kirshenbaum, Mountain View, CA (US); George H. Forman, Port Orchard, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/588,608

(22) Filed: Oct. 27, 2006

(51) Int. Cl. G06F 17/30

(52) U.S. Cl. 707/102; 707/E17.005

(57) ABSTRACT

To build a model, an expression related to a task to be performed with respect to a collection of cases is received, where the task is different from identifying features for building the model. A feature is produced from the expression, and a model is constructed based at least in part on the produced feature.

### CROSS-REFERENCE TO RELATED APPLICATION

This is related to U.S. Patent Application, entitled “Selecting a Classifier to Use as a Feature for Another Classifier” (Attorney Docket No. 200601867-1), filed concurrently herewith.

### BACKGROUND

Data mining is widely used to extract useful information from large data sets or databases. Examples of data mining tasks include classifying (in which classifiers are used to classify input data as belonging to different classes), quantifying (in which quantifiers are used to allow some aggregate value to be computed based on input data associated with one or more classes), clustering (in which clusterers are used to cluster input data into various partitions), and so forth. In performing data mining tasks, models are built, where the models can include classifiers (in the classifying context), quantifiers (in the quantifying context), clusterers (in the clustering context), and so forth.

To build a model, features are identified. Usually, such features are identified based on information associated with some collection of cases. In the classifier context, proper selection of features allows for more accurate training of a classifier from a collection of training cases. From the training cases and based on the selected features, an induction algorithm is applied to train the classifier, so that the classifier can be applied to other cases for classifying such other cases.

Examples of features for classifiers include binary indicators for indicating whether a particular case does or does not contain a particular property (such as a particular word or phrase) or is or is not describable by a particular property (such as being an instance of a shopping session that led to a purchase), a categorical indicator (to indicate whether a particular case belongs to some discrete category), a k numeric indicator to indicate a numeric value of some property associated with a case (e.g., age, price, count, frequency, rate), or a textual indicator (e.g., name of the case).

Features can also be derived features, which are features derived from other features. Examples of derived features can include a feature relating to profit that is computed from other attributes (profit computed based on subtracting cost from sale price), a feature derived from splitting text strings into multiple words, and so forth.

An issue associated with identifying derived features is that there are typically a very large number, not infrequently an unbounded number, of possible derived features. While the set of words contained in text strings associated with any training case may often be large, perhaps in the thousands, the number of bigrams (two-word sequences) will typically number in the millions, and the number of longer phrases will be astronomical. The set of regular expressions which could potentially match a text string is unbounded, as is the set of algebraic combinations of numeric features or Boolean combinations of binary features. Because there are so many possible features and so few are likely to be useful in building a high-quality classifier, it is typically intractable to attempt to automatically generate them.

Another conventional technique of generating features relies upon human experts to use their understanding of a particular domain to produce specific features that a particular model should consider. However, such a manual technique of producing features is time-consuming, complex, and often does not produce optimal features.

### BRIEF DESCRIPTION OF THE DRAWINGS

Some embodiments of the invention are described with respect to the following figures:

FIG. 1 is a block diagram of an example arrangement that includes a computer having a feature generator, according to some embodiments; and

FIG. 2 is a flow diagram of a process performed by the feature generator, according to an embodiment.

### DETAILED DESCRIPTION

A feature generator according to some embodiments produces derived features to use for building a model, where a model is a construct that specifies relationships to perform some computation involving input data (referred to as features) associated with cases for producing an output. In some embodiments, the model built is a data mining model, where a data mining model refers to any model that is used to extract information from a data set. A “case” refers to a data item that represents a thing, event, or some other item. Each case is associated with information (e.g., product description, summary of a problem, time of event, and so forth).. A “feature” refers to any indicator that can be used with respect to cases to be analyzed by a model. For example, in the classifying context, a feature is a predictive indicator to predict whether any given case belongs or does not belong to one or more particular classes (or categories) or has some property.

Some features (referred to as primitive features) can be produced based directly on information associated with some collection of cases. “Derived features” are features whose values with respect to a case is computed based on the values of other features with respect to that case or other cases. The selection of such other features and the manner of computing can be predefined or may be based on a source of information external to information associated with the cases. In accordance with some embodiments, one source of such external information includes queries submitted by users, such as queries submitted by users to retrieve some subset of cases matching the search expressions in the queries. For example, the queries may have been submitted by users for the purpose of retrieving cases from some collection of cases to use as training cases for building the model. The queries can also be submitted in other contexts, such as web queries submitted by users to a web server, queries submitted to a search engine (e.g., legal research engine, patent search engine, library search engine, etc.), and queries submitted to an e-commerce engine (e.g., online retail websites). The potential advantage of relying upon expressions in queries submitted by users in developing derived features for the purpose of building a model is that users (particularly users who possess special domain knowledge for which the model is being developed) may be assuming the utility of specific combinations that are well-known to those in the field but whose utility is not apparent from the cases themselves. Also, human users are usually good at noticing interesting and useful patterns in data. This user knowledge is represented by search expressions embedded in the queries, where the search expressions can be rather elaborate or complex search expressions that are useful as derived features (or that are useful for generating derived features). Thus, expressions contained within these queries can be logged for use in producing potential features in building models.

In addition to expressions contained in queries, other interactions can occur between users (or other external sources) and a system that performs some task(s) with respect to a collection of cases that are used for building a model. Such a system can produce some output according to the task(s). An example of such a system is a system used to develop training cases for training a classifier based on the collection of cases. One such system is a system that includes a search-and-confirm mechanism described in U.S. Ser. No. 11/118,178, entitled “Providing Training Information for Training a Categorizer,” filed Apr. 29, 2005. The search-and-confirm mechanism allows a user to submit queries to retrieve a subset of the collection of cases, where the subset is displayed to the user. The user is able to confirm or disconfirm whether the displayed cases belong or do not belong to a particular class (or classes). The user can specify what output fields of the cases are to be displayed in order to make the decision to confirm or disconfirm. In such a system a user may be allowed to specify the display of computed values, such as the elapsed time of a support call, computed based on timestamps associated with the call representing the start and end of the call. The specification by the user of what output fields of the cases or expressions based on data associated with the cases are to be displayed is a type of interaction that can be monitored by the feature generator according to an embodiment. Selection of output fields of interest to present can be performed also in other types of system. Such selections of output fields of interest constitute expressions that can be logged for producing derived features by the feature generator according to some embodiments. For example, when searching for real-estate properties of interest, if a user opts to show in the output display (1) the number of bedrooms and (2) the ratio of the number of bedrooms to total-square-feet, these, may be used for other purposes as potentially useful features to consider when building a predictive model about real-estate properties in general.

Another external source of information that can be used as derived features (or that can be used to produce derived features) are fields in a report (e.g., cells of a spreadsheet), where the report is produced by a system performing some task(s) with respect to the collection of cases and where the fields can be specified to be computed based on data associated with cases. The fields of the report can be considered expressions for producing derived features. Another external source of information includes values of the collection of cases to plot, such as in a graph, chart, and so forth.

Another external source of expressions for producing derived features is software code that performs some task(s) with respect to the collection of cases. The software code can include one or more expressions, e.g., if (p.revenue−p.cost)>100, that can be useful for producing derived features.

Generally, the feature generator according to some embodiments receives an expression that pertains to at least some cases in a collection of cases. It is noted that the received expression that pertains to at least some cases of a collection of cases is intended and used for a purpose other than identifying features for constructing a model. An example of an expression that is used for the purpose of identifying features for constructing a model includes any expression generated by a human expert for the purpose of producing features of a model. Another example of an expression that is used for the purpose of identifying features includes answers given by the human expert in response to the experts being asked for definitions of useful features, including phrases, numeric expressions, regular expressions, and so forth.

The received expression can include a search expression (such as a search expression contained in a query), an expression of selected fields of cases to output, an expression of fields contained in a report (e.g., cells in a spreadsheet), an expression of data to be plotted (such as in a graph, chart, etc.), an expression regarding a sort criterion (e.g., an expression that results are to be sorted by revenue), an expression regarding a highlight criterion (e.g., certain results are to be highlighted by a specific color), and an expression contained in software code. Based on the received expression, the feature generator produces at least one derived feature. The at least one derived feature is then used for constructing a model, which model can be applied to a given case by computing a value for the at least one derived feature based on data associated with the given case.

The feature generator according to some embodiments thus “audits” or “looks over the shoulder of” a user during interactions between the user and some system (where an interactive system can be a system for developing training cases based on user input, a web server system accessible by users over a network, or any other system in which a user is able to interact with the system to perform some task with respect to a collection of cases). The feature generator attempts to unobtrusively determine derived features that are thought important by the human user, observing expressions that the user comes up with in the course of doing a different task (that is, observing the expressions used by a person while he or she goes about their routine work—as opposed to the user explicitly taking on the task of identifying predictive features from which to build a predictive model). Thus, generally, the feature generator receives an expression related to an operation-related task to be performed with respect to a collection of cases, where the “operation-related task” is defined to refer to an activity that is different from identifying features for building a model.

One type of model that can be built is a classifier for classifying cases into one or more classes (or categories). Classifiers can be binary classifiers, which are classifiers that determine whether any particular case belongs or does not belong to a particular class. Multiple binary classes can be combined to form a classifier for multiple classes (referred to as a multiclass classifier). Other models for which derived features can be generated according to some embodiments include one or more of the following: a quantifier (for producing an estimate of the number of cases or of an aggregate of some data field, or multiple data fields, of cases belonging to one or more classes); a clusterer (for clustering data, such as text data, into different partitions or other sets of saliently similar data, also referred to as clusters); a set of association rules produced according to association rule-learning (which receives as input a data set and outputs common or interesting associations in the data); a functional expression resulting from function regression (which inputs a data set labeled with numeric or other target values and outputs a function that approximates the target for a case, e.g., to interpolate or extrapolate values beyond those provided in the data set); a predictor (a model that inputs a data set labeled with target values and outputs a function that approximates the target value for any item in the data set); a Markov model (a discrete-time stochastic process with Markov property—in other words, the probability distribution of future states of the process depends only upon the current state and not any past states); a strategy or state transition table based on reinforcement learning (a class of problems in machine learning involving an agent exploring an environment, in which the agent perceives its current state and takes an action); an artificial immune system model (a model that is a collection of patterns that have the property that the patterns do not match any of a set of exemplars that are of no interest to a user or users, often used to detect anomalies, intrusions, fraud, malware, and so forth); a strategy produced from strategy discovery (a model that takes an action in response to what is observed when the model is in a particular state); a decision tree model (a predictive model that is a function of features of a case to produce a conclusion about the case's target value); a neural network; a finite state machine (a model of behavior composed of states, transitions, and actions); a Bayesian network (a probabilistic graphical model that can be represented as a graph with probabilities attached) ; a naive Bayes model (a probabilistic classifier that is based on an independent probability model); a support vector machine (a supervised learning method used for classification and regression); an artificial genotype (model used in genetic programming or genetic algorithms); a functional expression (a mathematical (or other) expression over features, functions, and constants useable for classifying, clustering, predicting, etc.); a linear regression model (a model of the relationship between two variables that fits a linear equation to observed data); a logistic regression model (a predictive model for binary dependent variables that utilizes the logit as its link function); a computer program; an integer programming model (a model in which a function is maximized or minimized, subject to constraints, where variables of the function have integer values); and a linear programming model (a model in which a function is maximized or minimized, subject to constraints, where the function is linear).

In the ensuing discussion, reference is made to generating derived features for building classifiers. However, it is noted that the same or similar techniques can be applied for building other models, including those listed above, as examples.

Normally, in a possible feature space having a large number of terms (e.g., distinct words) that are based on information associated with a collection of cases, the number of possible multi-term combinations (e.g., two- or three-word combinations) can be immense. Often, to reduce the number of possibilities of derived features, the possible feature space is shrunk, such as by specifying that one or both words in a two-word phrase be among the hundred most frequent words overall. This approach would mean that the vast bulk of possible n-word phrases would be overlooked, potentially including some that would be very useful as derived features.

In accordance with some embodiments, useful derived features can be produced by the feature generator without shrinking the space of distinct terms. Expressions developed by users in interacting with the system (to perform a task that is different from the task of identifying features) are typically more likely to be useful than random combinations of distinct terms. The number of such derived features produced based on expressions from users can be much smaller in number compared to the number of possible multi-term combinations.

In one example, if a user issues a query containing an expression having a phrase “laser-printer” or “broken-power-supply” (where separating words by dashes is an example technique of specifying n-grams), the phrase can simply be added as a derived feature to the set of features, or alternatively, a derived feature is constructed from the phrase. As one example, the phrase can be added as a binary feature that indicates whether the entire phrase occurred in the appropriate textual field of each case. Alternatively, a numeric feature can be constructed indicating how many times the phrase occurred in the text of each particular case, or what fraction of the text of the case is constituted by the instances of the phrase. The feature generator thus allows for the selection of long n-grams without having to be burdened by noise from other (perhaps more frequent) n-grams such as “printer-would” or “still-won't”.

The technique of generating derived features based on expressions is even more useful when expressions containing queries involve regular expressions (or the more simplified glob expressions), as the number of possible derived features based on such expressions becomes even larger. Note that increasing the number of useful derived features (based on expressions), as opposed to just increasing the number of features based on random combinations of distinct terms, allows for building of more accurate models.

A “glob expression” is an expression containing an operator indicating presence of zero or more characters (e.g., *), an arbitrary character (e.g., ? symbol), a range of characters, or a range of strings. For example, if a user query involves crack*“where “*” is a wild card indicator to match “crack,” “cracked,” “cracks,” “cracking,” etc., then the user has provided a clue that “crack” is a good place to truncate words containing the string “crack” and that the notion of a case containing any of the matches may be useful. Similarly, “analy?e” can be used to match either the American version “analyze” or the British version “analyse” so that both spellings can be treated as the same word. As with n-grams, automatically trying all possible glob expressions or even just all possible truncations is computationally intractable; however, in accordance with some embodiments, producing derived features from glob expressions that are detected when looking at user queries is computationally much less intensive.

A “regular expression” is a string that describes or matches a set of strings according to certain syntax rules. An example of a regular expression is a search expression involving “/hp[A-Z]{3,5}(−\d+){3}/i”. The expression above matches any string of three-to-five letters following “hp,” followed by three groups of digits, the groups separated by dashes, and the whole match ignoring the case of letters. This type of search expression can be used, for example, to match a particular style of serial number. As the space of possible regular expressions is unbounded, it is typically very difficult to even consider ways of creating useful derived features in such a space. However, if a regular expression has been specified in a user query, then it is likely that such a regular expression can be useful for constructing derived features.

Derived features can also be based on synonyms of words given in expressions. Also, derived features can be based on substring matches (matching of a portion of a string), including punctuation. Such substring matches are indicated by substring expressions.

In addition to individual search expressions, a query often contains combinations (e.g., based on Boolean logic) of search terms, such as “screen AND cracked” to retrieve all cases whose text contains both the word “screen” and the word “cracked” in any order. Alternatively, the query may specify “screen AND NOT cracked” to retrieve all cases whose text contains the word “screen” but not the word “cracked.” Alternative example expressions include “screen OR cracked,” “(battery OR power) AND (empty OR charge) AND NOT boot.” Individual search terms can be regular expressions, glob expressions, expressions to match substrings, n-grams, and so forth.

When Boolean expressions are observed by the feature generator according to some embodiments, the entire expression can be added as a derived feature. However, the feature generator is able to further extract useful sub-expressions of the overall expression. For example, if a user query specifies “/batt?ery/AND drain*” to match cases that contain both “battery” (possibly misspelled by leaving out a “t”) and any word starting with “drain,” both the regular expression “/batt?ery/” and glob expression “drain*” can be added as candidate derived features.

Derived features can also be created from intermediate expressions, where an intermediate expression is one segment of a larger Boolean expression. For example, in “(battery OR power) AND (empty OR charge) AND NOT boot”, intermediate expressions might include “battery OR power,” “empty OR charge,” “(battery OR power) AND (empty OR charge),” “(battery OR power) AND NOT boot,” and “(empty OR charge) AND NOT boot.” In this case, the derived feature is produced by using a portion less than the entirety of the expression.

If additional derived features are desired, other combinations can follow the same structure of the expressions in the queries but can replace a conjunction or disjunction with one or the other of its arguments. In other words, Boolean operators in the expression can be replaced with different Boolean operators. From the above example, the following alternate expression can be derived: “battery AND (empty OR charge).” A scenario where the ability to extract different combinations from specified actual expressions of a user query is in the context of a user making queries that involve labels attached to cases or other information which is available in the system in which the user is making the query but which will not be available in the system in which the built classifier will be run and which therefore should not be considered for derived features. For example, a user query may have the following search expression: “(NOT labeled(BATTERY) OR predicted(SCREEN) AND batt*” to match those cases that contain words starting with “batt” and are either not explicitly labeled as being in the “BATTERY” class or predicted to be in the “SCREEN” class. A case labeled in a particular class refers to a user identifying the case as belonging to a particular class or the case having been determined to belong to the class by some other means. The ability to label a case as belonging or not belonging to a class can be provided by a user interface in which cases (such as cases retrieved in response to a user query) can be presented to a user to allow the user to confirm or disconfirm that the retrieved cases belong to any particular class. One such user interface is provided by a search-and-confirm mechanism described in U.S. Ser. No. 11/118,178, referenced above. Thus, in the above example expression, labeled(BATTERY) indicates that a case has been labeled in the BATTERY class, and predicted(SCREEN) refers to a classifier predicting that the case belongs to the SCREEN class.

An expression in which Boolean terms are combined (in any of the manners discussed above) is referred to as a “Boolean combination expression.” Another type of expression involves an expression that counts a number of Boolean values.

When the model to be constructed is to run in an environment in which it will deal with unlabeled cases (which is usually the scenario when trying to identify features for building a classifier), the search term “labeled(BATTERY)” would always be false, since an unlabeled case by definition is not labeled in any class. Thus, the search term “labeled(BATTERY)” would be useless as a derived feature for training a classifier, for example. A derived feature based on the above example expression would remove the “labeled(BATTERY)” part of the expression for use as a derived feature.

In another example, a search expression may make use of case data that is present in the training set but is known not to be available when the classifier is put into production. In such cases, all sub-expressions that depend entirely on such expressions should be removed. In this case, the “NOT labeled(BATTERY)” part is removed, which makes the disjunction reduce to simply “predicted(SCREEN)” and the entire expression to be reduced to “predicted(SCREEN) AND batt*”.

Other possible derived features can be produced based on proximity expressions, where a proximity expression specifies that two (or more) words (or glob expressions, regular expression, etc.) appear within the same sentence, paragraph, document section, or within a certain number of words (sentences, paragraphs, etc.) of one another. Another type of expression that can be used for deriving features is an ordering expression, which specifies that one word (sentence, paragraph, etc.) appears before another. The concept of proximity expressions and ordering expressions can also be combined.

To handle misspellings, an expression may specify some indicator that matches are to include likely misspellings of a target word. The alternate words that are likely misspellings can be suggested by a spellchecker. The notion here is usually that there is a bounded number (often one) of edits (insertions, deletions, replacements, transpositions) that would transform one word into another. This bounded number can be expressed by an “edit distance” or more formally a Levenshtein distance (or some other measure). The expression can thus specify the maximum distance (e.g., “misspelling(battery, 5)”) or the maximum may be assumed (e.g., “misspelling(battery)”).

Expressions may also include equalities and inequalities to allow the use of numeric values (counts, durations, etc.) associated with cases. A numeric expression including equality is referred to as a “numeric equality expression,” while a numeric expression that includes an inequality is referred to as a “numeric inequality expression.” From such expressions, derived features produced can involve constant thresholds (e.g., “cost <$25”) or multiple numeric features (e.g., “supportCost>profit”). Numeric features include as examples dates, durations, monetary values, temperatures, speeds, and so forth.

Queries can also specify numeric expressions to be computed from other values, such as “closeTime−openTime<20 min” or “revenue/(end-start) <$100/hr”, which allows the use of more complex features. These are referred to as “mathematical combination expressions.” To allow this, it may be desirable to be able to compute numbers from other types of features (and other sources) as well. For example, such numbers can include the number of times that a particular word (sentence, paragraph, etc.) is found in a text string (or the ratio of that to the length of the string), the probability assigned to a case by a classifier, the number of strings in a collection that contains a word (sentence, paragraph, etc.), or the average of a sequence of numbers. All of the above can be computed and used in inequalities.

As discussed above, derived features can be Boolean or numeric. Sub-expressions of expressions relating to numeric parameters can also be extracted. For example, from the query “revenue/(end-start)<$100/hr”, the sub-expressions “revenue/(end-start)” and “end-start” may also likely be considered for producing a derived feature.

In some example implementations, derived features have to be discrete values. In such a case, continuous numeric values would have to be binned to produce the discrete values. To allow binning, the feature generator must specify “cut points” that determine the maximum and/or minimum values for each bin. Numbers mentioned by users in inequalities (or, perhaps, any constants mentioned by users) can be taken by the feature generator as potential cut points. Alternatively, a user might be observed to explicitly define cut points for some field in preparation for issuing queries based on them or for purposes of display or graphing (e.g., producing a histogram or bar chart). For example, the user might be observed to define that a body temperature field has three bins, “normal: <99°, low-grade fever: 99°-101.5°, high fever: >101.5°.” Such a definition would allow issuing of a query containing an expression that performs some action based on the body temperature of a person (e.g., an expression such as “temperature IS normal” used to test whether the body temperature of a person is normal). Taking into account such cut points would allow the feature generator to not only add derived features for Boolean expressions (such as a Boolean feature according to the “temperature IS normal” example), but would also allow derived features including the numeric features binned by the rule. Note that it may be possible for the user to change the binning rule during the course of a session (or multiple sessions) and different users may define different cut points (or different numbers of bins) for the same numeric features. Each of these definitions could be used to define a new feature. With expressions such as “temperature IS normal,” it may be desirable to make use of all possible definitions of “normal” (defined by different users or by the same user at different times, for example), not merely the one in force when the query was made. Note also that a binning definition may apply to multiple fields or even a field type, such as “monetary value.” In that case, it may be possible to use the binning definition to bin numeric features derived from numeric expressions. For example, a set of cut points used to break up monetary values could be used not just on “revenue” and “cost” fields, but also on a derived “revenue−cost” measure.

Another sort of feature that can be derived from a query is based on similarity with an example (or set of examples). In this case, a user selects a case (or cases) or creates one on the fly, and asks to see cases “similar to this one/these.” This is known as query by example, in which the expression in the query specifies an example (or plural examples), and the system attempts to find similar cases. There are many different similarity measures that can be used, depending on the sort of data associated with the case. The derived features here would be the exemplar (the example case or cases) along with the similarity measure used.

Another form of derived feature is (or is based on) the output of another classifier. In this scenario, the expression from which the derived feature can be produced includes the classifier and its output. To use outputs of classifiers as features for other classifiers when the resulting model is to be run in an environment that includes both classifiers, a partial order is constructed to define the order in which classifiers are to be built, so that if the output of a particular classifier is to be used as (or in) a derived feature for a second classifier, then the first classifier is evaluated first. Also, the partial order ensures that if classifier A is using the output of classifier B to obtain the value for one of its derived features, then classifier B cannot use an output of classifier A to obtain the value for one of classifier B's derived features. Further details regarding developing the partial order noted above is described in U.S. Patent Application entitled “Selecting Output of a Classifier As a Feature for Another Classifier,” (Attorney Docket No. 200601867-1), filed concurrently herewith.

Instead of using an output of a classifier as a feature, other embodiments can use outputs of other predictors (which are models that take input data and make predictions about the input data) as features.

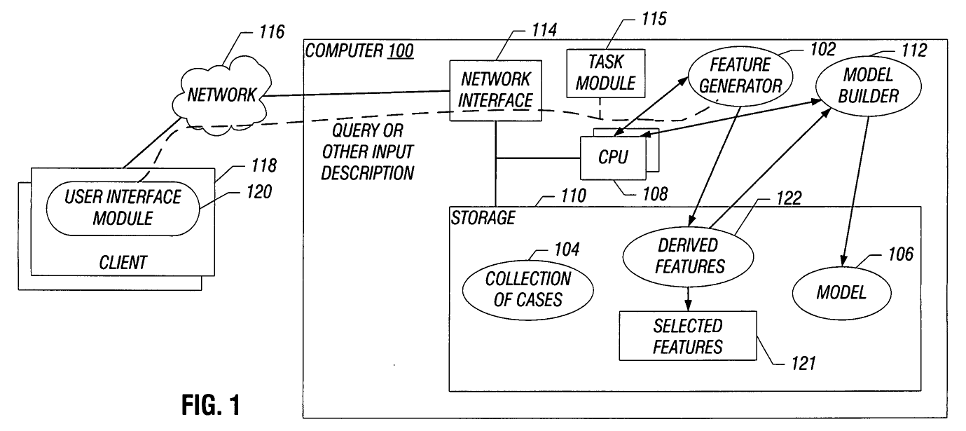

FIG. 1 illustrates an arrangement that includes a computer 100 on which a feature generator 102 according to some embodiments is executable. The computer 100 can be part of a larger system, such as a system for developing training cases to train classifiers (such as that described in U.S. Ser. No. 11/118,178, referenced above), a web server to which users can submit queries, or any other system that allows interaction with a user for performing some task relating to a collection of cases 104, where the task is different from the task of identifying features for building a model 106.

The feature generator 102 can be implemented as one or more software modules executable on one or more central processing units (CPUs) 108, where the CPU(s) 108 is (are) connected to a storage 110 (e.g., volatile memory or persistent storage) for storing the collection of cases 104 and the model 106 to be built. The model 106 is built by a model builder 112, which can also be a software module executable on the one or more CPUs 108.

The CPU(s) 108 is (are) optionally also connected to a network interface 114 to allow the computer 100 to communicate over a network 116 with one or more client stations 118. Each client station 118 has a user interface module 120 to allow a user to submit queries or to otherwise interact with the computer 100. To interact with the computer 100, the user interface module 120 transmits a query or other input description (that describes the interaction with the computer 100) to the computer 100. Note that the input description does not have to be with the computer 100, as the computer 100 can merely monitor input description sent to another system over the network 116. The input description can include expressions of fields of cases to output, expressions of fields contained in a report, expressions of values to plot, an expression regarding a sort criterion, an expression regarding a highlight criterion, or expressions in software code. The query or other input description is processed by a task module 115, which performs a task in response to the query or other input description. In addition, the query or other input description (containing one or more expressions) is monitored by the feature generator 102 for the purpose of producing derived features. These derived features are stored as 122 in the storage 110. From the produced derived features, the feature generator 102 or the model builder 112 can also select the most useful derived features (according to some score), where the selected derived features (along with other selected features) are provided as a set of features 121 to the model builder 112 for the purpose of building the model 106. The set of features 121 includes both the derived features 122 as well as normal features based directly on information associated with the collection of cases 104.

Alternatively, monitoring of current interaction between a user and the computer 100 (or another system) does not have to be performed by the feature generator 102. As an alternative, the feature generator may simply look at a log of queries that the user (or multiple users) generated on the computer 100 and/or other systems. More generally, the feature generator receives an expression (either in real time or from a log) related to some task that is different from identifying features for building a model, where the expression is provided to a first module (e.g., task module 115) in the computer 100 or another system. Note that the first module is a separate module from the feature generator. The first module can be a query or search interface to receive queries, an output interface to produce an output containing specified fields, a report interface to produce a report, or software containing the expression.

Although the collection of cases 104, set of features 121, and model 106 are depicted as being stored in the storage 110 of the computer 100, it is noted that these data structures can be stored separately in separate computers. Also, the feature generator 102 and the model builder 112 can be executable in different computers.

As noted, once the derived features 122 are generated, the model 106 is built. Note that building the model can refer to the initial creation of the model or a modification of the model 106 based on the derived features 122. In the example where the model 106 is a classifier, the building of the model 106 refers to initially training the classifier, whereas modifying the model refers to retraining the classifier. More generally, “training” a classifier refers to either the initial training or retraining of the classifier.

A trained classifier can be used to make predictions on cases as well as in calibrated quantifiers to give estimates of numbers of cases in each of the classes (or to perform some other aggregate with respect to the cases within a class). Also, classifiers can be provided in a form (such as in an Extensible Markup Language or XML file) and run off-line (such as separate from the computer 100) on other cases.

Staying with the classifier example, to train the classifier;, a selected number of the best features are selected. Then, weightings are obtained to distinguish the positive training cases from the negative training cases for a particular class based on the values for each feature for each training case. The weightings are associated with the features and applied during the use of a classifier to determine whether a case is a positive case (belongs to the corresponding class) or a negative case (does not belong to the corresponding class). Weightings are typically used for features associated with a naive Bayes model or a support vector machine model for building a binary classifier.

In some embodiments, feature selection is performed (either by the feature generator 102 or the model builder 112) by considering each feature in turn and assigning a score to the feature based on how well the feature separates the positive and negative training cases for the class for which the classifier is being trained. In other words, if the feature were used by itself as the classifier, the score indicates how good a job the feature will do. The m features with the best scores are chosen. In an alternative embodiment, instead of selecting the m best features, some set of features that leads to the best classifier is selected.

In some implementations, one of two different measures can be used for feature selection: bi-normal separation and information gain. A bi-normal separation measure is a measure of the separation between the true positive rate and the false positive rate, and the information gain measure is a measure of the decrease in entropy due to the classifier. In alternative implementations, feature selection can be based on one or more of the following types of scores: chi-squared value (based on chi-squared distribution, which is a probability distribution function used in statistical significance tests), accuracy measure (the likelihood that a particular case will be correctly identified to be or not to be in a class), an error rate (percentage of a classifier's predictions that are incorrect on a classification test set), a true positive rate (the likelihood that a case in a class will be identified by the classifier to be in the class), a false negative rate (the likelihood that an item in a class will be identified by the classifier to be not in the class), a true negative rate (the likelihood that a case that is not in a class will be identified by the classifier to be not in the class), a false positive rate (the likelihood that a case that is not in a class will be identified by the classifier to be in the class), an area under an ROC (receiver operating characteristic) curve (area under a curve that is a plot of true positive rate versus false positive rate for different threshold values for a classifier), an f-measure (a parameterized combination of precision and recall), a mean absolute rate (the absolute value of a classifier's prediction minus the ground-truth numeric target value averaged over a regression test set), a mean squared error (the squared value of a classifier's prediction minus the true numeric target value averaged over a regression test set), a mean relative error (the value of a classifier's prediction minus the ground-truth numeric target value, divided by the ground-truth target value, averaged over a regression test), and a correlation value (a value that indicates the strength and direction of a linear relationship between two random variables, or a value that refers to the departure of two variables form independence).

In alternative embodiments, feature selection can be omitted to allow the model builder 112 to use all available derived features (generated according to some embodiments) for building or modifying the model 106.

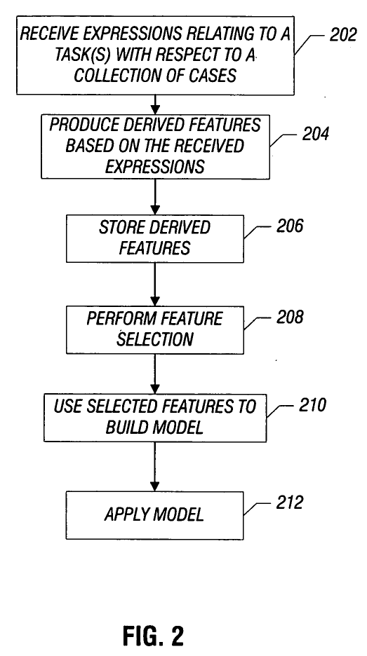

FIG. 2 is a flow diagram of a process performed by the feature generator and/or model builder 112, in accordance with an embodiment. Expressions relating to a task(s) with respect to a collection of cases are received (at 202) by the feature generator 102. These expressions are related to a task that is different from the task of identifying (generating, selecting, etc.) features for use in building a model. The expressions can be contained in queries or in other input descriptions (e.g., user selection of fields in cases to be output, fields in a report, data to be plotted, and software code) relating to interactions between a user and the computer 100 (FIG. 1).

Next, the feature generator 102 produces (at 204) derived features based on the received expressions. Various examples of derived features are discussed above. The derived features are then stored (at 206) as 122 in FIG. 1.

Next, feature selection is performed (at 208) by either the feature generator 102 or the model builder 112. The selected derived features can be the m best derived features according to some measure or score, as discussed above. Note that the feature selection can be omitted in some implementations.

The selected derived features (which can be all the derived features) are then used (at 210) by the model builder 112 to build the model 106. Note that the derived features are used in conjunction with other features (including those based directly on the information associated with the cases) to build the model 106. The model 106 is then applied (at 212) either in the computer 100 or in another computer on the collection of cases 104 or on some other collection of cases. Applying the model on a case includes computing a value for each selected derived feature based on data associated with the particular case. For example, if the model is a classifier, then applying the classifier to the particular case involves computing a value for the derived feature (e.g., a binary feature having a true or false value, a numeric feature having a range between certain values, and so forth) based on data contained in the particular case, and using that computed value to determine whether the particular case belongs or does not belong to a given class.

Applying the model to a particular case (or cases) allows for the new derived feature to refine results in a system (such as an interactive system). For example, in a system in which cases are displayed in clusters according to a clustering algorithm, using the new derived feature to apply the model to the cases may allow for refinement of the displayed clusters. In another example, the new derived features can be used to retrain classifiers that may be used to quantify data associated with cases or that may be used to answer future queries that involve classification.

Instructions of software described above (including feature generator 102 and model builder 112 of FIG. 1) are loaded for execution on a processor (such as one or more CPUs 108 in FIG. 1). The processor includes microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of building a data mining model, comprising:
receiving an expression related to an operation-related task to be performed with respect to a collection of cases;
producing a feature from the expression; and
constructing the data mining model based at least in part on the produced feature.

2. The method of claim 1 further comprising applying the data mining model to a particular case by computing a value for the feature based on data associated with the particular case.

3. The method of claim 1, wherein receiving the expression comprises receiving the expression in one of a query, a description of data to be displayed, a description of data to be plotted, a description of fields in a report, a description of a sort criterion, a description of a highlight criterion, and a description in software code, and wherein the operation-related task comprises one of performing querying, performing displaying of data, plotting data, reporting, sorting, highlighting, executing the software code, compiling the software code, and writing the software code.

4. The method of claim 1, wherein receiving the expression occurs in an interactive system.

5. The method of claim 4 further comprising applying the data mining model to a particular case within the interactive system.

6. The method of claim 1, wherein receiving the expression comprises observing the expression in one of a query made to a search engine, a query made to a system for training classifiers, a query submitted to a web server, and a query submitted to an electronic commerce engine.

7. The method of claim 1, wherein the data mining model comprises one of a classifier; a quantifier; a clusterer; a set of association rules produced according to association rule-learning; a predictor; a Markov model; a strategy or state transition table based on reinforcement learning; an artificial immune system model; a strategy produced by strategy discovery; a decision tree model; a neural network; a finite state machine; a Bayesian network; a naive Bayes model; a support vector machine; an artificial genotype; a functional expression; a linear regression model; a logistic regression model; a computer program; an integer programming model; and a linear programming model.

8. The method of claim 1, wherein constructing the data mining model comprises selecting the feature from a set of possible features.

9. The method of claim 8, wherein selecting the feature comprises computing a measure with respect to the feature, wherein the measure comprises one of: an information gain, a bi-normal separation value, chi-squared value, accuracy measure, an error rate, a true positive rate, a false negative rate, a true negative rate, a false positive rate, an area under an ROC (receiver operating characteristic) curve, an f-measure, a mean absolute rate, a mean squared error, a mean relative error, and a correlation value.

10. The method of claim 1, wherein receiving the expression comprises receiving at least one of a regular expression, a substring expression, a proximity expression, a glob expression, a numeric inequality expression, a numeric equality expression, a mathematical combination expression, an expression specifying a count of Boolean values, a Boolean combination expression, a binning rule, an output of a classifier, an output of a predictor, an expression of a measure of similarity, an expression specifying an edit distance, an expression to handle misspellings, and an expression to identify cases similar to an example case.

11. The method of claim 1, wherein producing the feature from the expression comprises performing one of: using the expression as the feature; using a portion less than an entirety of the expression as the feature; replacing Boolean logic operators in the expression; removing terms from the expression; identifying a synonym of a word contained in the expression.

12. A method comprising:
monitoring interaction between a system and a source, wherein the interaction relates to a collection of cases in the system;
identifying, from the interaction, a feature; and
building a model according to the feature.

13. The method of claim 12, further comprising identifying at least one additional feature from the interaction, wherein building the model is further according to the at least one additional feature.

14. The method of claim 12, wherein monitoring the interaction comprises monitoring at least one of: at least one query received from the source by the system; selection of at least one field to output; at least one field contained in a report; data to be plotted; a sort criterion; a highlight criterion; and expressions contained in software code.

15. The method of claim 12, wherein monitoring the interaction comprises retrieving information relating to the interaction from a log.

16. The method of claim 15, wherein the log further contains further information relating to other interactions between at least another source and at least another system, wherein identifying the feature is further based on the further information.

17. The method of claim 12, wherein the collection of cases comprises a collection of training cases for training a classifier with respect to at least one class, and wherein building the model comprises training the classifier.

18. Instructions on a computer-usable medium that when executed cause a system to:
process, by a first module, an expression to perform a task with respect to a collection of cases, wherein the task is different from identifying features for building a model;
receive the expression by a feature generator;
produce, by the feature generator, a feature from the expression; and
construct a model based at least in part on the produced feature.

19. The instructions of claim 18, wherein the first module comprises one of a query interface, an output interface, a report interface, and a software containing the expression.

20. The instructions of claim 18, wherein processing the expression comprises processing at least one of a regular expression, a substring expression, a proximity expression, a glob expression, a numeric inequality expression, a numeric equality expression, a mathematical combination expression, an expression specifying a count of Boolean values, a Boolean combination expression, a binning rule, an output of a classifier, an output of a predictor, an expression of a measure of similarity, an expression specifying an edit distance, an expression to handle misspellings, and an expression to identify cases similar to an example case.
